(19) United States
(12) Patent Application Publication
(10) Pub. No.: US 2025/0303352 A1
(43) Pub. Date: Oct. 2, 2025

(54) METHODS FOR ELIMINATING GAS FLARING DURING AMINE SWEETENING FACILITY SHUTDOWNS

(71) Applicant: SAUDI ARABIAN OIL COMPANY, Dhahran (SA)

(72) Inventors: Mohammed S. AL-SUWALIM, Dhahran (SA); Ahmed Dhiya AL-AHMED, Al Qatif (SA); Mohammed J. AL-KHAMIS, Dhahran (SA)

(73) Assignee: SAUDI ARABIAN OIL COMPANY, Dhahran (SA)

(21) Appl. No.: 18/619,986

(22) Filed: Mar. 28, 2024

(51) Int. Cl. B01D 53/14; B01D 53/22; C10L 3/10

(52) U.S. Cl. CPC B01D 53/1468; B01D 53/229; C10L 3/103; B01D 2252/20405; B01D 2256/24; B01D 2257/304

(57) ABSTRACT

Methods may comprise contacting a sour gas with a treatment in a contactor, wherein the treatment comprises an amine and the sour gas comprises a hydrocarbon gas and an acid gas; absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first flare gas; flashing the rich amine to produce a utility gas; stripping at least another portion of the acid gas from the rich amine to form a lean amine and a second flare gas; and treating the combined flare gas in a gas treatment unit to form a second sweetened gas and a natural gas liquid.

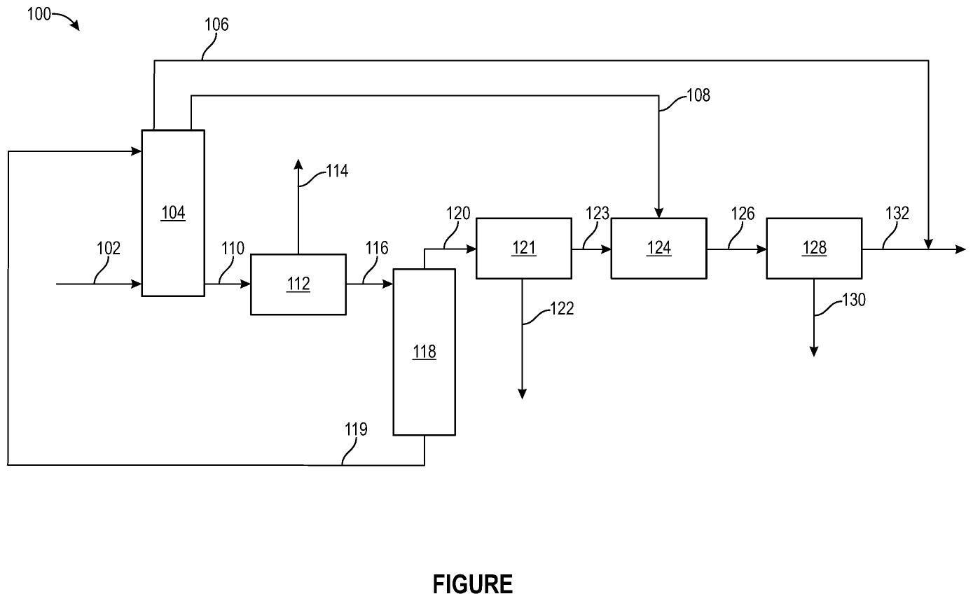

### FIELD OF THE DISCLOSURE

The present disclosure relates generally to natural gas treating and, more particularly, to shutdown processes of amine sweetening facilities.

### BACKGROUND OF THE DISCLOSURE

Natural gas treating, particularly the removal of acid gases, is a crucial step in purifying natural gas to render it suitable for commercial use. Sour gas, characterized by its high content of acid gases (e.g., hydrogen sulfide and/or carbon dioxide) is unsuitable for direct use due to safety, environmental, and operation concerns. Amine sweeting is a widely adopted natural gas treatment method involving the use of aqueous amine solutions having a high affinity for acid gases. In the amine sweetening process, the sour gas is contacted with the amine solution, facilitating a chemical reaction in which the acid gases bind to the amine, effectively removing the acid gases from the natural gas stream. This treatment yields a “sweetened” gas, significantly reducing the acid gas content to levels suitable for transportation and other various uses.

The shutdown procedure of an amine sweetening process is a critical operation, often necessitating gas flaring. Flaring, the controlled burning of natural gas, is typically employed during shutdowns for safety reasons and to prevent the accumulation of harmful gases within the treatment facility. This practice, however, raises significant environmental and economic concerns. Environmentally, flaring may contribute to air pollution through the release of various pollutants including sulfur dioxide, nitrogen oxides, and particulate matter in addition to greenhouse gases such as carbon dioxide and methane, the latter being particularly potent in its global warming potential. These emissions may be detrimental to air quality and contribute to climate change. Economically, flaring represents a loss of valuable resources. The burned gas is a potential source of energy that, if utilized, could offer substantial economic benefits. Moreover, the process indicates inefficiencies in the system and may lead to increased operational costs, including potential penalties for environmental damage and the looming threat of stricter regulations.

Thus, although amine sweetening is an indispensable process in natural gas treatment, ensuring the transformation of sour gas into commercially viable sweet gas, the associated shutdown procedures and reliance on gas flaring present considerable environmental and economic challenges. Addressing these issues necessitates a focus on the exploration of sustainable alternatives to flaring to mitigate the environmental impact and enhance the economic efficiency of natural gas processing.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods for eliminating gas flaring during amine sweetening facility shutdowns may comprise contacting a sour gas with a treatment in a contactor, wherein the treatment comprises an amine and the sour gas comprises a hydrocarbon gas and an acid gas; absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first flare gas; flashing the rich amine to produce a utility gas; after flashing the rich amine, stripping at least another portion of the acid gas from the rich amine to form a lean amine and a second flare gas, wherein the lean amine has an acid gas concentration less than the rich amine; combining the first flare gas and the second flare gas in a flare gas recovery system to form a combined flare gas; and treating the combined flare gas in a gas treatment unit to form a second sweetened gas and a natural gas liquid.

In another embodiment, methods for eliminating gas flaring during amine sweetening facility shutdowns may comprise contacting a sour gas with a treatment in a contactor, wherein the treatment comprises diglycolamine and the sour gas comprises a hydrocarbon gas and an acid gas; absorbing at least a portion of the acid gas by the diglycolamine, thereby producing a first sweetened gas having an acid gas concentration of about 4 ppm or less, a first flare gas having an acid gas concentration of about 10 ppm or less, and a rich amine having an acid gas concentration higher than the first flare gas; flashing the rich amine to produce a utility gas; after flashing the rich amine, stripping at least another portion of the acid gas from the rich amine to form a lean amine and a second flare gas having an acid gas concentration of about 100 ppm or less, wherein the lean amine has an acid gas concentration less than the rich amine; combining the first flare gas and the second flare gas in a flare gas recovery system to form a combined flare gas; and treating the combined flare gas in a gas treatment unit comprising a membrane separation unit to form a second sweetened gas having an acid gas concentration of about 4 ppm or less and a natural gas liquid.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The FIG. is a process flow diagram of a non-limiting example method of the present disclosure.

### DETAILED DESCRIPTION

Embodiments in accordance with the present disclosure generally relate to natural gas processing and, more particularly, to shutdown processes of amine sweetening facilities. As mentioned previously, while amine sweetening is a crucial process in the treatment of natural gas, vital for transforming sour gas into commercial sweet gas, the accompanying shutdown procedures and the consequent dependence on gas flaring introduce significant environmental and economic challenges. The present disclosure addresses the foregoing challenges though the addition of a separate gas treatment unit to the amine sweetening process. In the gas treatment unit, the gas that is normally flared during a conventional amine sweetening process may be further treated to remove remaining acid gases thereby producing additional sweetened gas that may be sold or utilized in other processes.

Therefore, methods of the present disclosure may comprise: contacting a sour gas with a treatment in a contactor, wherein the treatment comprises an amine and the sour gas comprises a hydrocarbon gas and an acid gas; absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first flare gas; flashing the rich amine to produce a utility gas; after flashing the rich amine, stripping at least another portion of the acid gas from the rich amine to form a lean amine and a second flare gas, wherein the lean amine has an acid gas concentration less than the rich amine; combining the first flare gas and the second flare gas in a flare gas recovery system to form a combined flare gas; and treating the combined flare gas in a gas treatment unit to form a second sweetened gas and a natural gas liquid.

As used herein, the term “acid gas” refers to a gas comprising sulfurous compounds (e.g., hydrogen sulfide or carbonyl sulfide) and/or carbon dioxide.

As used herein, the term “amine sweetening” refers to a process by which sour gas is treated with an amine solution, for example, an alkanolamine, to remove at least a portion of an acid gas from the sour gas.

As used herein, the term “natural gas liquids (NGLs)” or “natural gas condensates” refer to hydrocarbon liquids primarily composed of non-methane hydrocarbons such as ethane, propane, and butanes.

As used herein, the term “sour gas” refers to a natural gas comprising an acid gas. More specifically, sour gas may have a concentration of hydrogen sulfide greater than 10 ppm.

As used herein, the term “sweet gas” refers to a sour gas that has undergone a purification process to remove at least a portion of the sulfurous compounds and/or carbon dioxide present in the untreated sour gas, such as through amine sweetening.

The FIG. is a process flow diagram of a non-limiting example method of the present disclosure. In method 100, a sour gas 102 comprising a hydrocarbon gas and an acid gas is introduced to a multi-staged contactor 104 containing a treatment comprising an amine. The sour gas 102 may have a concentration of the acid gas making the sour gas unsuitable for commercial use. For example, the sour gas 102 may have an acid gas concentration of about 10 ppm or higher, or about 20 ppm or higher, or about 50 ppm or higher, or about 100 ppm or higher. In addition to the hydrocarbon gas and the acid gas, the sour gas 102 may also comprise water.

The amine, which may comprise a primary amine, secondary amine, and/or a tertiary amine, when contacted with the sour gas 102, may absorb at least a portion of the acid gas within the sour gas 102. Amines suitable for use in the present disclosure may include alkanoamines, or, more specifically, ethanolamines. Examples of suitable ethanolamines include, but are not limited to, diethanolamine, monoethanolamine, methyldiethanolamine, the like, and any combination thereof. Preferably, the amine may comprise diglycolamine. Moreover, the treatment may comprise amines such as diisopropanolamine.

The treatment, typically comprising a viscous solution, may be introduced to the contactor 104 at the top-most stage, while the gaseous sour gas 102 may be introduced at a lower stage. The contactor 104 may, for example, be an absorption column and may be at a pressure of about 150 psig to about 250 psig, or about 150 psig to about 225 psig, or about 150 psig to about 200 psig, or about 175 psig to about 250 psig, or about 175 psig to about 225 psig, or about 175 psig to about 200 psig.

Contacting the sour gas 102 with the treatment in the contactor 104 may result in the formation of a first sweetened gas 106, a first flare gas 108, and a rich amine 110. The first sweetened gas 106 may have an acid gas concentration lower than the initial sour gas 102, and may have an acid gas concentration low enough for the first sweetened gas 106 to be sold or further utilized in other processes. For example, the first sweetened gas 106 may have an acid gas concentration of about 4 ppm or less, or about 3 ppm or less, or about 2 ppm or less, or about 1 ppm or less.

The first flare gas 108 may have an acid gas concentration higher than the first sweetened gas 106, but lower than the sour gas 102. For example, the first flare gas 108 may have an acid gas concentration of about 10 ppm or less, or about 9 ppm or less, or about 8 ppm or less, or about 7 ppm or less, or about 6 ppm or less, or about 5 ppm or less.

A majority of the acid gas present in the sour gas 102 may be absorbed by the treatment. Consequently, the rich amine 110 may have an acid gas concentration higher than the first flare gas 108. The rich amine 110 may exist as a high-pressure liquid in which the acid gas is present in a liquid state. Therefore, the rich amine 110 may be flashed in a flash drum 112 such as by lowering the pressure of the rich amine 110. For example, the pressure of the flash drum 112 may be about 50 psig to about 100 psig, or about 50 psig to about 90 psig, or about 60 psig to about 100 psig, or about 60 psig to about 90 psig, or about 70 psig to about 100 psig, or about 70 psig to about 90 psig. This process may result in the formation of a utility stream 114. The utility stream 114 may primarily comprise hydrocarbons, with an acid gas concentration lower than the rich amine 110. In any embodiment, the utility stream 114 may be utilized in other processes, for example, as a combustion source for various equipment.

The flashed rich amine 116 may be further treated, such as by using a stripping column 118 at a pressure of about 10 psig to about 50 psig, or about 10 psig to about 40 psig, or about 10 psig to about 30 psig. Stripping the flashed rich amine 116 may further separate the acid gas absorbed by the treatment in the contactor 104. This stripping may result in the production of a lean amine 119 having an acid gas concentration lower than the rich amine 110 and flared rich amine 116. Therefore, the remaining acid gas may exit the stripping column 118 in the stripper outlet gas 120. The lean amine 119 may be optionally recycled to the contactor 104. Due to potential degradation of the amine, however, the lean amine 119 may optionally require supplementation with a makeup amine before introduction to the contactor 104.

The remaining sulfurous compounds 122 may be at least partially separated from the stripper outlet gas 120 in a separator 121 to form a second flare gas 123. The separator 121 may, for example, be at a pressure of about 10 psig to about 50 psig, or about 10 psig to about 40 psig, or about 10 psig to about 30 psig. The second flare gas 123 may, for example, have an acid gas concentration of about 10 ppm or less, or about 9 ppm or less, or about 8 ppm or less, or about 7 ppm or less, or about 6 ppm or less, or about 5 ppm or less. The sulfurous compounds 122 may be directed to a sulfur recovery unit.

Furthermore, the first flare gas 108 and the second flare gas 123 may be combined in a flare gas recovery system 124 thereby forming a combined flare gas 126. Utility stream 114 may also optionally be combined in the flare gas recovery system 124. The flare gas recovery system 124 may, for example, be at a pressure of about 10 psig to about 50 psig, or about 10 psig to about 40 psig, or about 10 psig to about 30 psig. The combined flare gas 126 may be further introduced to an additional gas treatment unit 128. The gas treatment unit 128 may comprise any suitable equipment for separating and/or fractioning hydrocarbons including, but not limited to, a membrane separator, a condenser, a distillation column, the like, and any combination thereof. The gas treatment unit 128 may similarly employ an amine to absorb acid gases. The gas treatment unit 128 may separate the combined flare 126 into a natural gas liquids stream 130 and a second sweetened gas 132. The second sweetened gas 132 may be optionally combined with the first sweetened gas 106 for utilization in various subsequent processes or for sale. The gas treatment unit 128 may, for example, be at a pressure of about 10 psig to about 50 psig, or about 10 psig to about 40 psig, or about 10 psig to about 30 psig.

Embodiments disclosed herein include:

A. A method for eliminating gas flaring during amine sweetening facility shutdowns, the method comprising: contacting a sour gas with a treatment in a contactor; wherein the treatment comprises an amine and the sour gas comprises a hydrocarbon gas and an acid gas; absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first sweetened gas and lower than the sour gas, and a rich amine having an acid gas concentration higher than the first flare gas; flashing the rich amine to produce a utility gas; after flashing the rich amine, stripping at least another portion of the acid gas from the rich amine to form a lean amine and a second flare gas; wherein the lean amine has an acid gas concentration less than the rich amine; combining the first flare gas and the second flare gas in a flare gas recovery system to form a combined flare gas; and treating the combined flare gas in a gas treatment unit to form a second sweetened gas and a natural gas liquid.

B. A method for eliminating gas flaring during amine sweetening facility shutdowns, the method comprising: contacting a sour gas with a treatment in a contactor; wherein the treatment comprises diglycolamine and the sour gas comprises a hydrocarbon gas and an acid gas; absorbing at least a portion of the acid gas by the diglycolamine, thereby producing a first sweetened gas having an acid gas concentration of about 4 ppm or less, a first flare gas having an acid gas concentration of about 10 ppm or less, and a rich amine having an acid gas concentration higher than the first flare gas; flashing the rich amine to produce a utility gas; after flashing the rich amine, stripping at least another portion of the acid gas from the rich amine to form a lean amine and a second flare gas having an acid gas concentration of about 100 ppm or less; wherein the lean amine has an acid gas concentration less than the rich amine; combining the first flare gas and the second flare gas in a flare gas recovery system to form a combined flare gas; and treating the combined flare gas in a gas treatment unit comprising a membrane separation unit to form a second sweetened gas having an acid gas concentration of about 4 ppm or less and a natural gas liquid.

Each of embodiments A and B may have one or more of the following additional elements in any combination:

Element 1: wherein the amine comprises an ethanolamine.

Element 2: wherein the ethanolamine comprises diglycolamine, diethanolamine, monoethanolamine, methyldiethanolamine, diisopropanolamine, or any combination thereof.

Element 3: wherein the treatment further comprises an additive.

Element 4: wherein the additive comprises piperazine, phosphoric acid, or a combination thereof.

Element 5: wherein the first sweetened gas has a hydrogen sulfide concentration of about 4 ppm or less.

Element 6: wherein the first flare gas has a hydrogen sulfide concentration of about 10 ppm or less.

Element 7: wherein the second sweetened gas has a hydrogen sulfide concentration of about 4 ppm or less.

Element 8: wherein the second flare gas has a hydrogen sulfide concentration of about 10 ppm or less.

Element 9: wherein the gas treatment unit comprises a membrane separation unit.

Element 10: the method further comprising recycling at least a portion of the lean amine to the contactor.

Element 11: the method further comprising forming a hydrogen sulfide-rich gas when stripping the rich amine.

Element 12: the method further comprising treating the hydrogen sulfide-rich gas in a sulfur recovery unit.

Element 13: wherein the sour gas further comprises water.

By way of non-limiting example, exemplary element combinations applicable to A and B include: 1 and 2; 1 and 3; 1 and 5; 1 and 6; 1 and 7; 1 and 8; 1 and 9; 1 and 10; 1 and 11; 1 and 13; 3 and 4; 3 and 5; 3 and 6; 3 and 7; 3 and 8; 3 and 9; 3 and 10; 3 and 11; 3 and 13; 5 and 6; 5 and 7; 5 and 8; 5 and 9; 5 and 10; 5 and 11; 5 and 13; 6 and 7; 6 and 8; 6 and 9; 6 and 10; 6 and 11; 6 and 13; 7 and 8; 7 and 9; 7 and 10; 7 and 11; 7 and 13; 8 and 9; 8 and 10; 8 and 11; 8 and 13; 9 and 10; 9 and 11; 9 and 13; 10 and 11; 10 and 13; 11 and 12; 11 and 13; 1, 2, and 3; 2, 3, and 5; 3, 5, and 6; 5, 6, and 7; 6, 7, and 8; 7, 8, and 9; 8, 9, and 10; 9, 10, and 11; and 10, 11, and 13.

The present disclosure is further directed to the following non-limiting causes:

Clause 1. A method comprising:
contacting a sour gas with a treatment in a contactor;
   wherein the treatment comprises an amine and the sour gas comprises a hydrocarbon gas and an acid gas;
absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first flare gas;
flashing the rich amine to produce a utility gas;
after flashing the rich amine, stripping at least another portion of the acid gas from the rich amine to form a lean amine and a second flare gas;
   wherein the lean amine has an acid gas concentration less than the rich amine;
combining the first flare gas and the second flare gas in a flare gas recovery system to form a combined flare gas; and
treating the combined flare gas in a gas treatment unit to form a second sweetened gas and a natural gas liquid.

Clause 2. The method of clause 1, wherein the amine comprises an ethanolamine.

Clause 3. The method of clause 2, wherein the ethanolamine comprises diglycolamine, diethanolamine, monoethanolamine, methyldiethanolamine, diisopropanolamine, or any combination thereof.

Clause 4. The method of clause 1, wherein the treatment further comprises an additive.

Clause 5. The method of clause 4, wherein the additive comprises piperazine, phosphoric acid, or a combination thereof.

Clause 6. The method of clause 1, wherein the first sweetened gas has a hydrogen sulfide concentration of about 4 ppm or less.

Clause 7. The method of clause 1, wherein the first flare gas has a hydrogen sulfide concentration of about 10 ppm or less.

Clause 8. The method of clause 1, wherein the second sweetened gas has a hydrogen sulfide concentration of about 4 ppm or less.

Clause 9. The method of clause 1, wherein the second flare gas has a hydrogen sulfide concentration of about 10 ppm or less.

Clause 10. The method of clause 1, wherein the gas treatment unit comprises a membrane separation unit.

Clause 11. The method of clause 1, further comprising recycling at least a portion of the lean amine to the contactor.

Clause 12. The method of clause 1, further comprising forming a hydrogen sulfide-rich gas when stripping the rich amine.

Clause 13. The method of clause 12, further comprising treating the hydrogen sulfide-rich gas in a sulfur recovery unit.

Clause 14. The method of clause 1, wherein the sour gas further comprises water.

Clause 15. A method comprising:
contacting a sour gas with a treatment in a contactor;
   wherein the treatment comprises diglycolamine and the sour gas comprises a hydrocarbon gas and an acid gas;
absorbing at least a portion of the acid gas by the diglycolamine, thereby producing a first sweetened gas having an acid gas concentration of about 4 ppm or less, a first flare gas having an acid gas concentration of about 10 ppm or less, and a rich amine having an acid gas concentration higher than the first flare gas;
flashing the rich amine to produce a utility gas;
after flashing the rich amine, stripping at least another portion of the acid gas from the rich amine to form a lean amine and a second flare gas having an acid gas concentration of about 100 ppm or less;
   wherein the lean amine has an acid gas concentration less than the rich amine;
combining the first flare gas and the second flare gas in a flare gas recovery system to form a combined flare gas; and
treating the combined flare gas in a gas treatment unit comprising a membrane separation unit to form a second sweetened gas having an acid gas concentration of about 4 ppm or less and a natural gas liquid.

Clause 16. The method of clause 15, wherein the treatment further comprises an additive.

Clause 17. The method of clause 16, wherein the additive comprises piperazine, phosphoric acid, or a combination thereof.

Clause 18. The method of clause 16, further comprising recycling at least a portion of the lean amine to the contactor.

Clause 19. The method of clause 16, further comprising forming a hydrogen sulfide-rich gas when stripping the rich amine.

Clause 20. The method of clause 19, further comprising treating the hydrogen sulfide-rich gas in a sulfur recovery unit.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
contacting a sour gas with a treatment in a contactor;
wherein the treatment comprises an amine and the sour gas comprises a hydrocarbon gas and an acid gas;
absorbing at least a portion of the acid gas by the amine, thereby producing a first sweetened gas having an acid gas concentration lower than the sour gas, a first flare gas having an acid gas concentration higher than the first sweetened gas and lower than the sour gas, and a rich amine having an acid gas concentration higher than the first flare gas;
flashing the rich amine to produce a utility gas;
after flashing the rich amine, stripping at least another portion of the acid gas from the rich amine to form a lean amine and a second flare gas;
wherein the lean amine has an acid gas concentration less than the rich amine;
combining the first flare gas and the second flare gas in a flare gas recovery system to form a combined flare gas; and
treating the combined flare gas in a gas treatment unit to form a second sweetened gas and a natural gas liquid.

2. The method of claim 1, wherein the amine comprises an ethanolamine.

3. The method of claim 2, wherein the ethanolamine comprises diglycolamine, diethanolamine, monoethanolamine, methyldiethanolamine, diisopropanolamine, or any combination thereof.

4. The method of claim 1, wherein the treatment further comprises an additive.

5. The method of claim 4, wherein the additive comprises piperazine, phosphoric acid, or a combination thereof.

6. The method of claim 1, wherein the first sweetened gas has a hydrogen sulfide concentration of about 4 ppm or less.

7. The method of claim 1, wherein the first flare gas has a hydrogen sulfide concentration of about 10 ppm or less.

8. The method of claim 1, wherein the second sweetened gas has a hydrogen sulfide concentration of about 4 ppm or less.

9. The method of claim 1, wherein the second flare gas has a hydrogen sulfide concentration of about 10 ppm or less.

10. The method of claim 1, wherein the gas treatment unit comprises a membrane separation unit.

11. The method of claim 1, further comprising recycling at least a portion of the lean amine to the contactor.

12. The method of claim 1, further comprising forming a hydrogen sulfide-rich gas when stripping the rich amine.

13. The method of claim 12, further comprising treating the hydrogen sulfide-rich gas in a sulfur recovery unit.

14. The method of claim 1, wherein the sour gas further comprises water.

15. A method comprising:
contacting a sour gas with a treatment in a contactor;
wherein the treatment comprises diglycolamine and the sour gas comprises a hydrocarbon gas and an acid gas;
absorbing at least a portion of the acid gas by the diglycolamine, thereby producing a first sweetened gas having an acid gas concentration of about 4 ppm or less, a first flare gas having an acid gas concentration of about 10 ppm or less, and a rich amine having an acid gas concentration higher than the first flare gas;
flashing the rich amine to produce a utility gas;
after flashing the rich amine, stripping at least another portion of the acid gas from the rich amine to form a lean amine and a second flare gas having an acid gas concentration of about 100 ppm or less;
wherein the lean amine has an acid gas concentration less than the rich amine;
combining the first flare gas and the second flare gas in a flare gas recovery system to form a combined flare gas; and
treating the combined flare gas in a gas treatment unit comprising a membrane separation unit to form a second sweetened gas having an acid gas concentration of about 4 ppm or less and a natural gas liquid.

16. The method of claim 15, wherein the treatment further comprises an additive.

17. The method of claim 16, wherein the additive comprises piperazine, phosphoric acid, or a combination thereof.

18. The method of claim 16, further comprising recycling at least a portion of the lean amine to the contactor.

19. The method of claim 16, further comprising forming a hydrogen sulfide-rich gas when stripping the rich amine.

20. The method of claim 19, further comprising treating the hydrogen sulfide-rich gas in a sulfur recovery unit.
